(19) United States
(12) Patent Application Publication
(10) Pub. No.: US 2001/0044720 A1
(43) Pub. Date: Nov. 22, 2001

(54) Natural English language search and retrieval system and method

(76) Inventors: Victor Wai Leung Lee, Waterloo (CA); Chris Semotok, Toronto (CA); Otman Basir, Kitchener (CA); Fakhri Karray, Waterloo (CA)

Correspondence Address: Jones, Day, Reavis & Pogue, North Point, 901 Lakeside Avenue, Cleveland, OH, 44114, US

(21) Appl. No.: 09/732,190

(22) Filed: Feb. 26, 2001

Related U.S. Application Data
(60) Provisional application No. 60/169,414, filed on Dec. 7, 1999.

(51) Int. Cl. G10L 15/04

(52) U.S. Cl. 704/251

(57) ABSTRACT

A computer-implemented method and system for searching and retrieving using natural language. The method and system receive a text string having words (12). At least one of the words is identified as a topic word (16). Remaining words are classified either as a prefix description or a postfix description (16). A data store (32) is searched based upon the identified topic word, prefix description, and postfix description (30). Results from the searching are scored based upon occurrence of the identified topic word, prefix description, and postfix description in the results (34).

### RELATED APPLICATION

This application claims priority to U.S. provisional application Ser. No. 60/169,414 entitled NATURAL ENGLISH LANGUAGE SEARCH AND RETRIEVAL SYSTEM AND METHOD filed Dec. 7, 1999. By this reference, the full disclosure, including the drawings, of U.S. provisional application Ser. No. 60/169,414 are incorporated herein.

### BACKGROUND OF THE INVENTION

1. Field of the Invention

The present invention relates generally to the field of computer searching and retrieval, and more particularly to the field of computer searching and retrieval using natural English language input into the search system.

2. Description of the Related Art

Search and retrieval systems using natural English language input are known in this art. These systems, however, are typically very complex, cumbersome, and costly to implement. Thus, the applicability of these systems to general search and retrieval tasks has been limited. More specifically, these known search and retrieval systems have had very little penetration into the Internet space because of these disadvantages. The known systems do not have a less complex, streamlined, and cost effective search and retrieval system and method that process natural English language inputs.

### SUMMARY

The present invention solves the aforementioned disadvantages as well as other disadvantages. In accordance with the teachings of the present invention, a computer-implemented method and system is provided for searching and retrieving using natural language. The method and system receive a text string having words. At least one of the words is identified as a topic word. Remaining words are classified either as a prefix description or a postfix description. A data store is searched based upon the identified topic word, prefix description, and postfix description. Results from the searching are scored based upon occurrence of the identified topic word, prefix description, and postfix description in the results.

### BRIEF DESCRIPTION OF THE DRAWINGS

The present invention satisfies the general need noted above and provides many advantages, as will become apparent from the following description when read in conjunction with the accompanying drawing, wherein:

FIG. 1 is a flow chart of the preferred natural English language search and retrieval methodology according to the present invention; and

FIG. 2 is a block diagram depicting the computer-implemented components of the present invention.

### DETAILED DESCRIPTION OF THE PREFERRED EMBODIMENT

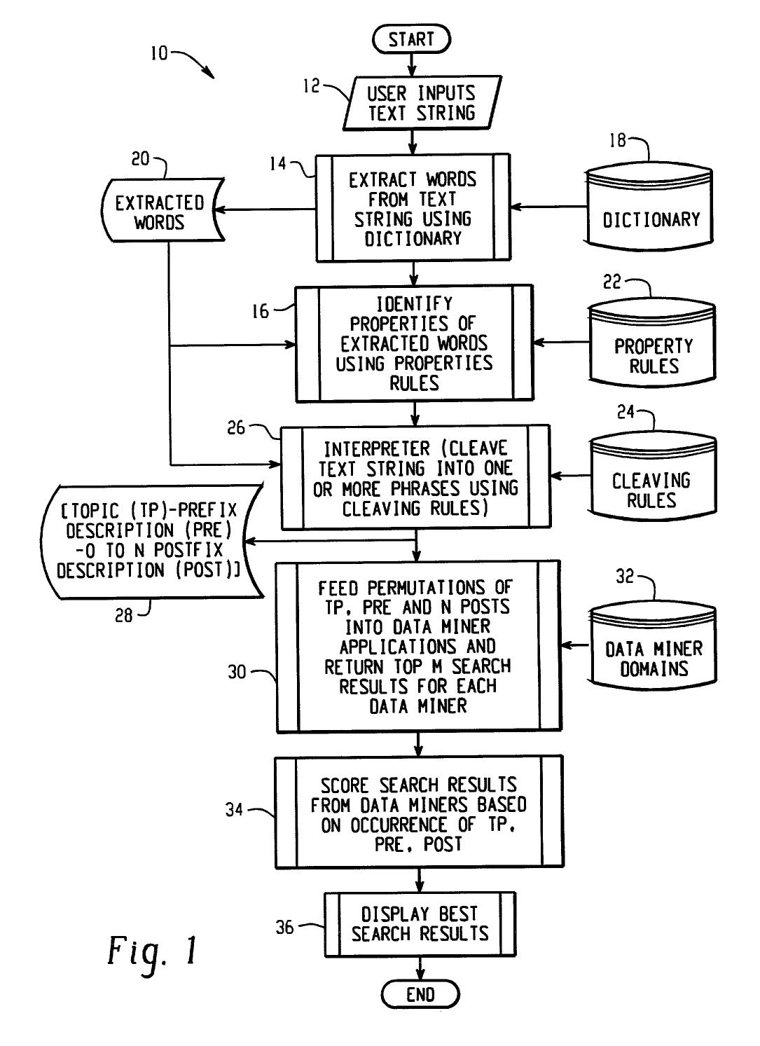

Turning now to the drawing figures, FIG. 1 sets forth a flow chart 10 of the preferred search and retrieval methodology of the present invention. The method begins at step 12, where the user of the system inputs an English sentence or keywords in the form of a text string. The first stage of the system 14 then extracts words from the text string by using spaces as delimiters. Each word is then found in a dictionary 18 to obtain its properties. If the word is not found in the dictionary 18 it is assumed to be a noun. The dictionary 18 contains over 50,000 words with each word associated with one or more properties. These part of speech properties include noun, adjective, adverb, verb, conjunction, determiner (e.g., an article, and preposition). The extracted words are held in an extracted word file 20.

The next stage 16 of the system determines a single property for each word stored in the extracted words file 20 using a set of properties rules 22. Because there are words in the dictionary 18 that have multiple properties, a set of properties rules 22 is needed in order to arrive at the correct property. The rule schema 22 uses the word in question as a pivot and examines the properties of the word before and the properties of the word after the word being analyzed. A decision can only be made when the word before and/or the word after has a single property. If the pivot word's properties cannot be determined because the word before and after has multiple properties, the algorithm proceeds to the next word as the pivot. This process is repeated twice to find a single property for each word. If the rule schema 22 cannot find a single property for a word the default is the first property. The last word of the text string is forced to be a noun.

The last stage 26 of the system is an interpreter that cleaves the input sentence into phrases based upon the singular properties of the words as identified in step 16. The delimiter of each phrase is a conjunction, preposition or a comma. The last noun of the first phrase is taken to be the topic (TP). The nouns and adjectives before the topic in the first phrase is termed the Prefix Description (Pre). The nouns and adjectives contained in the following phrases are termed the Postfix Description (Post). There is typically one Pre and one or more Posts. The topic, Prefix Description and N Postfix Description(s) are stored 28 for use in the search stages 30-36.

The input into the search stages 30-36 include a topic containing a single word, a prefix description containing a collection a words, and a postfix description containing a collection a words.

In the first step of the search stage 30, the system feeds one or more permutations of TP, Pre and Posts into one or more data miner applications. The data miner applications use data miner domain information 32 in order to apply the search permutations to various Internet domains. Each of the data miner applications then returns its top M search results for the particular Internet domain searched. The system provides the ability to customize the search and retrieval process by specifying what domains to search, and hence what data miners to execute.

All of the M search results from the selected data miners are then combined and scored based on the occurrence of TP, Pre, and Posts within the search results at step 34. The score is calculated by the occurrence of each word contained in the topic, prefix and postfix descriptions. Additional points are give if an exact match is made using the same order of words found in the prefix description and the topic. At step 36, these scored results across the multiple domains are then presented to the user as the results of the search.

Attached to this application as appendices A-G are the Java source code files that reflect the preferred embodiment of the methodology depicted in FIG. 1. These appendices include: (A) Parser module (which extracts words and find properties); (B) Words Manipulator module (which cleaves sentences into phrases, and associated files); (C) One Subject data structure; (D) One Word data structure; (E) Word Grouping List data structure; (F) Word List data structure; and (G) Filter module (which ranks results according to topic, prefix description, postfix descriptions).

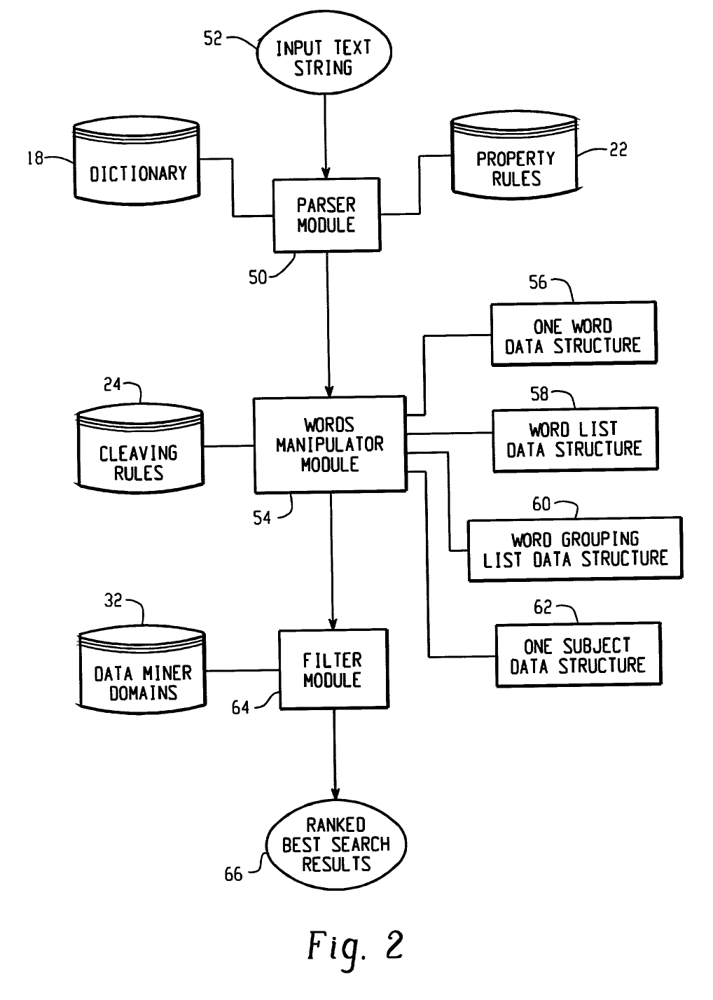

FIG. 2 describes the Java source code modules set forth in Appendices (A)-(G). With reference to FIG. 2, the Parser module 50 receives a user input text string 52. The Parser module 50 reads in dictionary 18 that in this example contains 50,000 words and their associated property codes. The Parser module 50 takes the user input text string 52 and tokenizes it into a data structure using spaces as delimiters. The Parser module 50 uses a binary search algorithm to find each word in the dictionary 18 and determine its property codes. Properties include noun, adjective, adverb, verb, conjunction, determiner, and preposition.

If the word is not found in the dictionary 18 it is assumed to be a noun. The Parser module 50 uses the properties rules base 22 to determine a single property code for each word. The rule schema uses the word in question as a pivot and examines the properties of the word before and the properties of the word after. The decision is made when the word before and/or the word after has a single property. If the pivot word's properties cannot be determined because the word before and after has multiple properties the algorithm proceeds to the next word as the pivot. The process is repeated twice to find a single property for each word. If the rule schema cannot find a single property for a word the default is the first property. Moreover, the last word of the text string is forced to be a noun.

The Words Manipulator module 54 takes each set of words and property codes and places it into the One Word data structure 56. Each group of the One Word data structure 56 is then cleaved using conjunctions, prepositions, and commas as delimiters into phrases that are stored in the Word List data structure 58. Each entry in the Word List data structure 58 is added to the Word Grouping List data structure 60.

The Word Grouping List data structure 60 is decomposed into the One Subject data structure 62 containing topic, prefix description, and postfix descriptions. The last noun of the first phrase of the Word List data structure 58 is taken to be the topic. Nouns and adjectives before the topic in the first phrase of the Word Grouping List data structure 60 form the prefix description. Nouns and adjectives contained in the following phrases in the Word Grouping List data structure 60 are taken as the postfix description.

More specifically with respect to the data structures, the One Word data structure 56 contains a word and its property code. The Word List data structure 58 contains a phrase of nouns and adjectives. The Word Grouping List data structure 60 contains a group of phrases. The One Subject data structure 62 contains topic, prefix description, postfix descriptions.

The Filter module 64 generates permutations of topic, prefix and postfix descriptions. The data miner domain information 32 which may include Internet information uses the permutations to search a domain and return the top results. Results are ranked according to topic, prefix description, postfix descriptions. Points are scored highest for exact matches. A Topic match is scored high, then prefix description and the least points are given to a postfix description match. The ranked best search results 66 are returned to the user.

These examples show that the preferred embodiment of the present invention can be applied to a variety of situations. However, the preferred embodiment described with reference to the drawing figures is presented only to demonstrate such examples of the present invention. Additional and/or alternative embodiments of the present invention should be apparent to one of ordinary skill in the art upon reading this disclosure.

```
import java.util.Vector;
import java.util.StringTokenizer;
public class Parser
{
  //These are the result to be returned.
  public Vector sentence = new Vector();
  public Vector coding = new Vector();
  // These are the dictionary
  Vector Words;
  Vector Coding;
```

public Parser(Vector W, Vector C)
{

Words=W;
Coding=C;

}
public void parse(String line)
{

sentence = new Vector();
coding = new Vector();
stringTokens(sentence, line);

parsing(sentence, coding, Words, Coding);
identify(sentence, coding);

}

```
public Vector sendSentence() {
  return (Vector) sentence;
}
public Vector sendCoding() {
  return (Vector) coding;
}
// binary search algorithm to find a word in the dictionary
String binarySearch(Vector Words, String searchKey, Vector Codes)
{
```

int mid, high, low;
String match;
low=0;
high = Words.size()-1;
mid=(high+low)/2;

match=new String(Words.elementAt(mid).toString());
//iterative binary searching technique
while(searchKey.compareTo(match)!=0 && high>low)
{

if(searchKey.compareTo(match)< 0) high=mid-1;
else low=mid+1;
mid=(high+low)/2;
match=new String(Words.elementAt(mid).toString());
}
if(searchKey.compareTo(match)==0) return new String(Codes.
elementAt(mid).toString());

else return new String(“”);

}
// 13/08/99 -Johnny
public boolean isInteger(String intStr) {

boolean flag = true;
int counter = 0;
int index = 0;
if ((intStr.substring(0,1).equals(“+”)) ||

(intStr.substring(0,1).equals(“−”)) ||
(intStr.substring(0,1).equals(“$”)))
intStr = new String(intStr.substring(1));

if (intStr.length()<=0)

flag = false;

while (flag && (index<intStr.length())) {

if ( intStr.substring(index,index+1).equals(“.”) &&

(intStr.length()>1) ) {

counter++;
if (counter>1)

flag = false;

}
else if (!( intStr.substring(index,index+1).equals(“0”) ||

```
  intStr.substring(index,index+1 ).equals(“1”) ||
  intStr.substring(index,index+1 ).equals(“2”) ||
  intStr.substring(index,index+1 ).equals(“3”) ||
  intStr.substring(index,index+1 ).equals(“4”) ||
  intStr.substring(index,index+1 ).equals(“5”) ||
  intStr.substring(index,index+1 ).equals(“6”) ||
  intStr.substring(index,index+1 ).equals(“7”) ||
  intStr.substring(index,index+1 ).equals(“8”) ||
  intStr.substring(index,index+1 ).equals(“9”) ))
```

flag = false;

index++;

}
return flag;

}
//parsing method to search the each word for the sentence
in the dictionary
void parsing(Vector sentence, Vector coding, Vector Words,
Vector Codes)
{

int i=0;

```
  String temp;
  //search the word list to find the code for
each word in the sentence
```

for(i=0;i<sentence.size();i++)
{

// 13/08/99 -Johnny
// check to see if it is a number

```
if (isInteger(sentence.elementAt(i).toString()))
  temp = new String(“#”);
else
  temp = binarySearch(Words,sentence.
elementAt(i).toString(),Codes);
// if no match try searching with lower case
if (temp.compareTo(“”) == 0)
temp = binarySearch(Words,sentence.
elementAt(i)toString().toLowerCase(),Codes);
```

coding.addElement(temp.trim());

}

```
}
// convert Vectors to a String
public String convertString(Vector sentence, Vector coding)
{
  String output =new String(“”);
  // save each word from the sentence along with its corresponding code
```

for (int i = 0; i < sentence.size() ; i++
{
output = new String(output + sentence.elementAt(i).
toString());

if(coding.elementAt(i).toString().comparerTo(“”)
!=0) output = new String(output + “” +

coding.elementAt(i).toString());

if(i<sentence.size()-1) output = new String(output + “”);

}
return output;

}
//identify words that have multiple codes
void identify(Vector sentence. Vector coding)
{

String temp, hold;

```
  StringTokenizer tok;
  Vector output= new Vector(), current= new Vector(),
before= new Vector(), after= new Vector();
  int i=0, x=0;
  // make a copy of coding
  for(i=0; i < coding.size(); i++)
  {
```

output.addElement(coding.elementAt(i));

```
  }
  //determine which words have multiple codes and set output to “1”
  for(i=0; i < coding.size(); i++)
  {
```

if(coding.elementAt(i).toString().compareTo(“”)!=0)
{

tok = new StringTokenizer(coding.elementAt(i).
toString(),“,”),
hold = new String(tok.nextToken());
if(tok.hasMoreTokens()) output.setElementAt(“1”, i);

}
else
{

if( sentence.elementAt(i).toString().compareTo(“,”)!=0 &&

sentence.elementAt(i).toString().compareTo(“:”)!=0 &&
sentence.elementAt(i).toString().compareTo(“;”)!=0 &&
sentence.elementAt(i).toString().compareTo(“?”)!=0 &&
sentence.elementAt(i).toString().compareTo(“.”)!=0 &&
sentence.elementAt(i).toString().compareTo(“!”)!=0)
output.setElementAt(“n”, i);

}

}
for(i=0;i < coding.size();i++)
{

//find word with multiple codes
if(output.elementAt(i).toString().compareTo
(“1”)==0)
{

//tokenize the code of the current word

tok = new StringTokenizer(coding.elementAt(i).
toString(), “,”);
while(tok.hasMoreTokens()) current.addElement
(new String(tok.nextToken()));

//tokenize the code of the word before
if((i-1) >=0) {

tok = new StringTokenizer(coding.elementAt(i-1).
toString(),“,”);

while(tok.hasMoreTokens()) before.addElement(new
String(tok.nextToken()));

}
//tokenize the code of the word after
if((i+1) < coding.size()) {

tok = new StringTokenizer(coding.elementAt(i+1).
toString(), “,”);

while(tok.hasMoreTokens()) after.addElement(new String
(tok.nextToken()));

}
//scenarios of before and after with the possible number
of codes
if(before.size() == 0 && after.size() == 0)

output.setElementAt(current.elementAt(0), i);

else if(before.size() == 1 && after.size() > 1)

output.setElementAt(rules(before.elementAt(0).toString(),
coding.elementAt(i).toString(),

“b”),i);

else if(before.size() > 1 && after.size() == 1)

output.setElementAt(rules(after.elementAt(0).toString(),
coding.elementAt(i).toString(), “a”),i);

else if(before.size() == 0 && after.size() == 1)

output.setElementAt(rules(after.elementAt(0).toString(),
coding.elementAt(i).toString(), “a”),i);

else if(before.size() == 1 && after.size() == 0)

output.setElementAt(rules(before.elementAt(0).toString(),
coding.elementAt(i).toString(),

“b”),i);

else if(before.size() == 1 && after.size() == 1)
{

temp = rules(before.elementAt(0).toString(),
coding.elementAt(i).toString(), “b”);
if(temp.compareTo(“1”)==0) temp = rules(after.
elementAt(0).toString(),

coding.elementAt(i).toString(), “a”);

output.setElementAt(temp,i);

}

}
//make sure that the last word in the sentence is a noun
if(i==coding.size()-1)
{

output.setElementAt(“n”, coding.size()-1);

}
current.removeAllElements();
after.removeAllElements();
before.removeAllElements();
//update coding to new determined code
if(output.elementAt(i).toString().compareTo(“1”) != 0)
{

coding.setElementAt(output.elementAt(i),i);

}
//use the first code as default
else
{

tok = new StringTokenizer(coding.elementAt(i).toString(), “,”);
coding.setElementAt(new String(tok.nextToken()),i);

}

```
  }
}
//rule base to distingusih which code to use
String rules(String s1, String s2, String type)
{
  int done;
  StringTokenizer tok;
  String out=“1”, temp;
  tok = new StringTokenizer(s2, “,”);
  // set of rules for the word before
  if(type.compareTo(“b”)==0)
  {
```

done = 0;
//search through the possible codes
while(tok.hasMoreTokens() && done == 0)
{

temp = new String(tok.nextToken());
if(s1.compareTo(“d”) == 0 && temp.compareTo(“n”) == 0)
{

done=1;
out = “n”;

}
else if(s1.compareTo(“qu”) == 0 && temp.compareTo(“v”) == 0)
{

done=1;
out = “v”;

}
else if(s1.compareTo(“c”) == 0 && temp.compareTo(“n”) == 0)
{

done=1;
out = “n”;

}
else if(s1.compareTo(“p”) == 0 && temp.compareTo(“v”) == 0)
{

done=1;
out = “v”;

}
else if(s1.compareTo(“d”) == 0 && temp.compareTo(“a”) == 0)
{

done=1;
out = “a”;

}
else if(s1.compareTo(“d”) == 0 && temp.compareTo(“n”) == 0)
{

done=1;
out = “n”;

}
else if(s1.compareTo(“v”) == 0 && temp.compareTo(“n”) == 0)
{

done=1;
out = “n”;

}
else if(s1.compareTo(“a”) == 0 && temp.compareTo(“n”) == 0)
{

done=1;
out = “n”;

}
else if(s1.compareTo(“a”) == && temp.compareTo(“a”) == 0)
{

done=1;
out = “a”;

}
else if(s1.compareTo(“#”) == 0 && temp.compareTo(“n”) == 0)
{

done=1;
out = “n”;

}

}

```
  }
  // set of rules for the word after
  else
  {
```

done = 0;
//search through the possible codes
while(tok.hasMoreTokens() && done == 0)
{

temp = new String(tok.nextToken());
if(temp.compareTo(“v”) == 0 && s1.compareTo(“d”) == 0)
{

done=1;
out = “v”;

}
else if(temp.compareTo(“d”) == 0 && s1.compareTo(“n”) == 0)
{

done=1;
out = “d”;

}
else if(temp.compareTo(“v”) == 0 && s1.compareTo(“p”) == 0)
{

done=1;
out = “v”;

}
else if(temp.compareTo(“p”) == 0 && s1.compareTo(“v”) == 0)
{

done=1;
out = “p”;

}
else if(temp.compareTo(“d”) == 0 && s1.compareTo(“a”) == 0)
{

done=1;
out = “d”;

}
else if(temp.compareTo(“d”) == 0 && s1.compareTo(“n”) == 0)
{

done=1;
out = “d”;

}
else if(temp.compareTo(“v”) == 0 && s1.compareTo(“v”) == 0)
{

done=1;
out = “v”;

}
else if(temp.compareTo(“a”) == 0 && s1.compareTo(“n”) == 0)
{

done=1;
out =“a”;

}
else if(temp.compareTo(“a”) == 0 && s1.compareTo(“a”) == 0)
{

done=1;
out = “a”;

}
else if(temp.compareTo(“n”) == 0 && s1.compareTo(“c”) == 0)
{

done=1;
out = “n”;

}

}

}
return new String(out);

}
//break up string into tokens
void stringTokens(Vector sentence, String line)
{

StringTokenizer tok, toking;
String temp = new String(“”);
toking = new StringTokenizer(new String(line));
//saves the command line strings to a vector
while(toking.hasMoreTokens())

{

temp = new String(toking.nextToken());
// removes the punctuation from the strings and adds it
separately to the sentence
if(temp.indexOf(“,”) > -1)
{

tok = new StringTokenizer(temp, “,”);
sentence.addElement(new String(tok.nextToken()));
sentence.addElement(“,”);

}
else if(temp.indexOf(“.”) > -1)
{

tok = new StringTokenizer(temp, “.”);
sentence.addElement(new String(tok.nextToken()));

}
else if(temp.indexOf(“?”) > -1)
{

tok = new StringTokenizer(temp, “?”);
sentence.addElement(new String(tok.nextToken()));

}
else if(temp.indexOf(“!”) > -1)
{

tok = new StringTokenizer(temp, “!”);
sentence.addElement(new String(tok.nextToken()));

}
else
{

sentence.addElement(temp);
}

}

}

```
}
import java.util.Vector;
public class WordsManipulator
{
  protected WordGroupingList groupingList;
  protected float price;
  public WordsManipulator(Vector sent, Vector codes)
  {
```

WordList wordList = new WordList();
Vector list = new Vector();
groupingList = new WordGroupingList();
price = 0;
for (int i=0; i<sent.size(); i++)
{

| // get the word and its corresponding property from the parser | |
|---|---|
| String word = new String(sent.elementAt(i).toString()); | |
| String property = new String(codes.elementAt(i).toString()); | |
| // assumption: there is only one subject, and associated adjectives | |
| // | and nouns for each clause |

// checks for clause breaks indicator - refer to parser for
symbols
if (property.equals(“c”) || property.equals(“pr”)
|| property.equals(“jv”) || word.equals(“,”))
{

// if there are words in the clause when a break occurs, store
// the list
if (!list.isEmpty())
{

// add the single clause lists to the rest of the list
wordList.addGroup(list);
// make a new list of more clauses
list = new Vector();

}

}
else if (property.equals(“n”) || property.equals(“a”)
|| property.equals(“#”))
{

// only stores the nouns and adjectives of the clause
OneWord single = new OneWord(word , property);
// add each (word, property) pair into the list
list.addElement(single);

}
// stores the last clause if the list is not empty
if ((i == (sent.size()-1)) && !list.isEmpty())

wordList.addGroup(list);

```
  }
  String noun; // stores each noun
  Vector adjList; // stores each adjective corresponding to the noun
  for (int i=0; i<wordList.getGroupSize(); i++)
  {
```

// assumption: the last noun is the subject of the clause
noun = new String(wordList.getElement(i, wordList.
getSubGroupSize(i)-1).getWord());
adjList = new Vector();
if (isMoney(noun))
{

if (!noun.substring(0,1).equals(“$”))

noun = new String(“$” + wordList.
getElement(i, wordList.getSubGroupSize(i)-2).getWord());

}
else
{

// the rest of the list, excluding the last word, are the words
// describing the noun
for (int j=0; j<wordList.getSubGroupSize(i)-1; j++) {

String word = new String(wordList.getElement(i,j).getWord());
// if the word is a number, combined the following word
with number
if (wordList.getElement(i,j).getProperty().equals(“#”) &&

| | |
|---|---|
| (j<(wordList.getSubGroupSize(i)-2)) | && |
| (!word.substring(0,1).equals(“$”)) | && |

(isMoney(wordList.getElement(i,j+1).getWord())) )

{

word = new String(“$” + word);
j++;

}
adjList.addElement(word);

}

}
// add the (noun, list) pair into the OneSubject object
OneSubject subject = new OneSubject(noun, null,adjList);
// add the OneSubject object into a vector list
groupingList.addGroup(subject);

}
}
public boolean isMoney(String str) {

| | |
|---|---|
| if (str.substring(0,1).equals(“$”) | \|\| |

str.toLowerCase().equals(“dollars”)||
str.toLowerCase().equals(“dollar”) ||
str.toLowerCase().equals(“buck”) ||
str.toLowerCase().equals(“bucks”))
return true;

return false:
}
public OneSubject send Query() {
// assumption; there is only one idea in each sentence, ie. a single

| | |
|---|---|
| // | subject(noun), and other words(noun or adjectives), |
| // | describing the subject |

```
String mainSubject = new String(“”); // the main subject
Vector precede = new Vector(); // stores words before topic
Vector description = new Vector(); // stores each word or phrase in here
OneSubject queryString; // the (subject, description) pair
String word = new String(“”);
// loop depends on the number of clauses
for (int i=0; i<groupingList.getSize(); i++)
{
  // get the (noun, adjlist) pair of each clause
  OneSubject subject = groupingList.getElement(i);
  // assumption; the noun in the first clause is always the subject of
```

| | |
|---|---|
| // | each sentence |

```
  if(i == 0)
  {
```

mainSubject = subject.getWord();
// leave the adjectives or nouns seperately
for (int j=0; j<subject.getList().size(); j++)
{

word = subject.getList().elementAt(j).toString();
if (isMoney(word)) {

Integer num = new Integer(word.substring(1, word.length()));
price = num.floatValue();

}
else
{

precede.addElement(word);

}

}

```
  }
  else
  {
```

// combine everything in this clause into a phrase and stores it
for (int j=0; j<subject.getList().size(); j++)
{

word = new String(subject.getList().elementAt(j).toString());
if (isMoney(word))
{

Integer num = new Integer(word.substring(1, word.length()));
price = num.floatValue();

}
else
{

description.addElement(word);
}

}

word = subject.getWord();
if (isMoney(word))
{

Integer num = new Integer(word.substring(1, word.length()));
price = num.floatValue();

}
else
{

description.addElement(word);

}

}

}
queryString = new OneSubject(mainSubject, precede, description);

return queryString;

```
  }
  public WordGroupingList getWordGroup() {
```

return groupingList;

```
  }
  public float priceScan() {
```

return price;

}
}
public class OneWord {

| | |
|---|---|
| private String word; | // any regular word or punctuation |

```
  private String property; // the grammatical property of the
corresponding word
  public OneWord() {}
  public OneWord(String word, String property) {
```

this.word = word;
this.property = property;

```
  }
  public String getWord() {
```

return word;

```
  }
  public String getProperty() {
```

return property;

```
  }
}
import java.util.Vector;
public class Word List {
  private Vector ListsOfWords;
  public WordList() {
```

ListsOfWords = new Vector();

```
  }
  public void addGroup(Vector group) {
```

ListsofWords.addElement(group);

```
  }
  public Vector getGroup(int groupindex) {
```

// check the bounds: empty list, and groupIndex is not bigger
than size
if (!ListsOfWords.isEmpty() && (groupIndex <= ListsOfWords.
size()))

return (Vector)ListsOfWords.elementAt(groupIndex);

return null;

```
  }
  public OneWord getElement(int groupIndex, int elementIndex) {
```

// check bounds again
if (!ListsOfWords.isEmpty() && (groupIndex <= ListsOfWords.
size())) {

Vector tmpVector = (Vector)ListsOfWords.
elementAt(groupIndex);
// check bounds again
if (!tmpVector.isEmpty() && (elementIndex <=
tmpVector.size()))

return (OneWord)tmpVector.elementAt(elementIndex);

}
return null;

```
  }
  public int getGroupSize() {
```

// get the size of the list
return ListsOfWords.size();

```
  }
  public int getSubGroupSize(int groupIndex) {
```

if (groupIndex <= ListsOfWords.size()) {

// get the size of the number of words in each list
Vector tmpVector = (Vector)ListsOfWords.
elementAt(groupIndex);
return tmpVector.size();

}
return -1;

```
  }
}
import java.util.Vector;
public class WordGroupingList {
  private Vector WordGroupList;
  public WordGroupingList() {
```

WordGroupList = new Vector();

```
  }
  public void addGroup(OneSubject subject) {
```

WordGroupList.addElement(subject);

```
  }
  public OneSubject getElement(int groupIndex) {
```

// check the bounds: empty list, and groupIndex is not bigger
than size
if (!WordGroupList.isEmpty() && (groupIndex <=
WordGroupList.size()))

return (OneSubject)WordGroupList.elementAt(groupIndex);

return null;

```
  }
  public int getSize() {
```

// get the size of the list
return WordGroupList.size();

```
  }
}
import java.io.Serializable;
import java.util.Vector;
public class OneSubject implements Serializable
{
  private String word; // the subject of the clause
  private Vector precede;
  private Vector listOfDescription; // the adjectives or nouns
associated to the subject
  public OneSubject() {}
  public OneSubject(String word, Vector prec, Vector list) {
```

| | |
|---|---|
| this.word | = word; |
| this.precede | = prec; |

this.listOfDescription = list;

```
  }
  public String getWord() {
```

return word;

```
  }
  public Vector getList() {
```

return (Vector) listOfDescription;

```
  }
  public Vector getPre() {
```

return (Vector) precede;

```
  }
}
  package com.ejunction.util;
  import com.ejunction.dataminer.Product;
  import java.util.Vector;
  import com.ejunction.product.ProductResults;
  public class Filter {
```

public Filter() {}
public ProductResults RankingResults(ProductResults
ProductList, Vector prec, String item, Vector

desc)

{

ProductResults qr=null;
try
{

int PPOINTS=2, IPOINTS=3, DPOINTS=1, EXACT=0,
BONUS=3;
Vector points=new Vector();
qr = ProductList;
int i=0,j=0,descPoints=0,namePoints=0;
boolean dexactFlag, nexactFlag;
String nameText=new String(“”);
String descText=new String(“”);
String frontText=new String (“”);
if(qr!=null && qr.description!=null && !qr.
description.isEmpty())
{

if(prec!=null && !prec.isEmpty())
{

frontText = new String(“”);
for(j=0;j<prec.size();j++)
{

frontText = new String(frontText + “” + prec.
elementAt(j).toString().toLowerCase());
EXACT+=PPOINTS, //points possible by precede

}
frontText = new String(frontText.trim() +“”+ item.
toLowerCase());
EXACT+=IPOINTS + BONUS; //Add Bonus
//System.out.printIn(“Exact” + EXACT);

}
else
{

DPOINTS=PPOINTS;

}
for(i=0;i<qr.descriptlon.size();i++)
{

descPoints=0;
namePoints=0,
Product product= (Product) qr.description.elementAt(i);
if(product.description == null){descText=new
String(“”); product.description=new String(“”);}
else descText=new String(product.description.
toLowerCase());
if(product.name == null) {nameText = new String
(“”); product.name=new String(“”);}
else name Text=new String(product.name.
toLowerCase());

```
  if(product.buyLink == null) {product.buyLink=new String(“”);}
  if(product.name.compareTo(“”)!=0 && product.buyLink.
compareTo(“”)!=0)
  {
```

if(desc!=null)
{

for(j=0;j<desc.size();j++)
{

if(descText.indexOf(desc.elementAt(j).toString().
toLowerCase())>-1)

descPoints+=DPOINTS;

if(nameText.indexOf(desc.elementAt(j).toString().
toLowerCase())>-1)

namePoints+=DPOINTS;

}

}
dexactFlag=false;
nexactFlag=false;
if(item.toLowerCase().compareTo(“book”)!=0)
{

if(frontText.compareTo(“”)!=0)
{

if(descText.indexOf(frontText)>-1)
{

descPoints+=EXACT;
dexactFlag = true;

}
if(nameText.indexOf(frontText)>-1)
{

namePoints+=EXACT;
nexactFlag = true;

}

}
if(!dexactFlag && descText.indexOf(item.toLowerCase())>-1)

descPoints+=IPOINTS,

if(!nexactFlag && nameText.indexOf(item.toLowerCase())>-1)

namePoints+=IPOINTS;

}
if(prec!null)
{

for(j=0;j<prec.size();j++)
{

if(!dexactFlag && descText.indexOf(prec.elementAt(j).
toString().toLowerCase())>-1)

descPoints+=PPOINTS;

if(!nexactFlag && nameText.IndexOf(prec.elementAt(j).
toString().toLowerCase())>-1)

namePoints+=PPOINTS;

}

}

}

if(descPoints>namePoints)

points.addElement((new Integer(descPoints)).toString());

else

points.addElement((new Integer(namePoints)).toString());

}
QuickSort(points,0,qr.description.size()-1,qr);
//Give top 20 results
if(qr.description.size()>20)
{

int qrSize = qr.description.size();
int siZe = 0;
for(i=0;i<(qrSize-20);i++)

qr.description.removeElementAt((qrSize-1)-i);

}
//Kill
int productSize = qr.description.size()-1
for(i=productSize;i>=0;i--)
{

Product prd= (Product) qr.description.elementAt(i);
if(((new Integer(points.elementAt(i).toString())).intValue() < 1))
{

points.removeElementAt(i);
qr.description.removeElementAt(i);

}
else
{

i=-1;

}

}

/*

long start.current;
//Print out
for(i=0;i<qr.description.size();i++)
{

Product pt = (Product) qr.description.elementAt(i);
//System.out.printIn(pt.name);
//System.out.printIn(pt.description);
System.out.printIn(i+1 +“.) Points: ” +points.
elementAt(i).toString());
start = System.currentTimeMillis();
current = start;
while(current-start < 500 ){current = System.
currentTimeMillis();}

}

*/

}

```
  }catch(Exception e){System.out.printIn(“Error in Filter; ”+e);}
  return qr;
}//
public void QuickSort(Vector points, int start, int end, Product
Results ProductList) throws Exception
{
  int low,high;
  low = start;
  high = end;
  int pivot = (new Integer(points.elementAt(end).toString())).
intValue();
  do {
```

while((low<high)&&((( new Integer( points.elementAt(low).
toString())).intValue())>= pivot))

low++;

while( (high>low)&&(((new Integer(points.elementAt(high).
toString())).intValue())<=pivot))

high−−;

if(low<high)

swap(points,low,high,ProductList);

```
  } while(low<high);
  swap(points,low,end,ProductList);
  if(low-1>start)
```

QuickSort(points,start,low-1 ProductList);

if(end>low+1)

QuickSort(points,low+1,end,ProductList);

return;
}
public void swap(Vector points, int i, int j, ProductResults ProductList)
throws Exception
{

Object tempPoint = points.elementAt(i);
points.setElementAt(points.elementAt(j), i);
points.setElementAt(tempPoint, j);
Object TempProduct = ProductList.description.elementAt(i),
ProductList.description.setElementAt(ProductList.description.
elementAt(j),i);
ProductList.description.setElementAt(TempProduct,j);

```
}
public ProductResults PriceScan(ProductResults ProductList,
float price) {
  ProductResults qr=null;
  try
  {
```

qr = new ProductResults();
Product product;
if(ProductList!null && ProductList.description!=null)
{

for (int i=0; i<ProductList.description.size(); i++)
{

product = (Product)ProductList.description.elementAt(i);
if (product.price <= price)
{

qr.description.addElement(product);

}

}

}

else return null;

}catch(Exception e){System.out.printIn(“Error in PriceScan: “+e);}
return qr;

}
}

It is claimed:

1. A computer-implemented searching method, comprising the steps of:
receiving a text string having words;
identifying at least one of the words as a topic word;
identifying at least one of the words as a prefix description;
identifying at least one of the words as a postfix description;
searching a data store based upon the identified topic word, prefix description, and postfix description; and
scoring results from the searching based upon occurrence of the identified topic word, prefix description, and postfix description in the results.

2. The method of claim 1 wherein the text string is a natural English sentence.

3. The method of claim 1 wherein the text string includes keywords.

4. The method of claim 1 further comprising the step of:
locating the words in a dictionary to determine part of speech properties for the words.

5. The method of claim 4 wherein the part of speech properties include properties selected from the group consisting of noun, verb, conjunction, determiner, and preposition.

6. The method of claim 4 further comprising the step of:
determining at least one word to be a noun based upon not locating the word in the dictionary.

7. The method of claim 1 wherein a first word is one of the words, said method further comprising the steps of:
locating the first word in a dictionary;
determining the first word has at least two part of speech properties based upon the locating the first word in the dictionary;
examining properties of the words neighboring the first word to determine which part of speech property the first word is; and
determining a single part of speech property of the word based upon the examined properties of the neighboring words.

8. The method of claim 1 wherein a first word is one of the words, said method further comprising the steps of:
locating the first word in a dictionary;
determining the first word has at least two part of speech properties based upon the locating the first word in the dictionary;
examining words adjacent to the first word to determine which part of speech property the first word is; and
performing the following steps if a single part of speech property is not able to be determined from the examined adjacent words:
selecting one of the adjacent words, examining part of speech properties of the words adjacent to the selected word, and determining a single part of speech property of the first word based upon the examined part of speech properties of the words adjacent to the selected word.

9. The method of claim 1 further comprising the step of:
determining a single part of speech property for each of the words in order to classify each of the words as either a topic word, a prefix description word, or a postfix description word.

10. The method of claim 1 further comprising the steps of:
determining part of speech properties for the words;
parsing the text string into phrases based upon delimiters in the text string; and
identifying last noun of the first of the phrases as the topic word.

11. The method of claim 10 further comprising the step of:
identifying nouns and adjectives before the topic word in the first of the phrases as the prefix description.

12. The method of claim 11 further comprising the step of:
identifying as the postfix description nouns and adjectives in the phrases subsequent to the first phrase.

13. The method of claim 12 wherein the delimiters are items selected from the group consisting of commas, conjunctions, and prepositions.

14. The method of claim 1 further comprising the steps of:
generating a first permutation of the topic word, prefix description, and postfix description;
performing a first search of the data store based upon the first permutation;
generating a second permutation of the topic word, prefix description, and postfix description;
performing a second search of the data store based upon the second permutation; and
scoring results from the first and second searches based upon occurrence of the identified topic word, prefix description, and postfix description in the results.

15. The method of claim 1 wherein the data store is a data miner domain.

16. The method of claim 1 wherein the data store includes a plurality of data miner domains, said method further comprising the step of:
searching the data miner domains based upon the identified topic word, prefix description, and postfix description.

17. The method of claim 16 wherein a user selects the data miner domains to be searched.

18. The method of claim 1 further comprising the step of:
improving a score of a search result that has substantially same order of words found in the prefix description and the topic word.

19. The method of claim 1 further comprising the steps of:
scoring results from the searching based upon occurrence of the identified topic word, prefix description, and postfix description in the results; and
presenting to a user the results from the searching ordered in accordance with the results' scores.

20. The method of claim 1 further comprising the steps of:
associating a first score to a search result that contains the topic word;
associating a second score to a search result that contains the prefix description, wherein the first score is higher than the second score; and
generating total scores for the searching results using the first and second scores.

21. The method of claim 20 further comprising the steps of:
associating a third score to a search result that contains the postfix description,
wherein the second score is higher than the third score; and
generating total scores for the searching results using the first, second, and third scores.

22. A computer-implemented system for searching based upon an input text string that contains words, comprising:
a parser module that identifies at least one of the words as a topic word and that identifies at least one of the words as a prefix description; and
a filter module connected to the parser module to search a data store based upon the identified topic word and prefix description,
said filter module scoring results from the searching based upon occurrence of the identified topic word and prefix description in the results.

23. The system of claim 22 wherein the parser module identifies at least one of the words as a postfix description,
wherein the parser module searches the data store based upon the identified topic word, prefix description, and postfix description;
wherein the results are scored based upon occurrence of the identified topic word, prefix description, and postfix description in the results.

24. The system of claim 23 wherein the text string is a natural English sentence.

25. The system of claim 23 wherein the text string includes keywords.

26. The system of claim 23 further comprising:
a dictionary connected to the parser module to locate the words in a dictionary to determine part of speech properties for the words.

27. The system of claim 26 wherein the part of speech properties include properties selected from the group consisting of noun, verb, conjunction, determiner, and preposition.

28. The system of claim 26 wherein the parser module determines at least one word to be a noun based upon not locating the word in the dictionary.

29. The system of claim 23 wherein a first word is one of the words, said system further comprising:
means for locating the first word in a dictionary;
means for determining the first word has at least two part of speech properties based upon the locating the first word in the dictionary;
means for examining properties of the words neighboring the first word to determine which part of speech property the first word is; and
means for determining a single part of speech property of the word based upon the examined neighboring words.

30. The system of claim 23 wherein a first word is one of the words, said system further comprising:
means for locating the first word in a dictionary;
means for determining the first word has at least two part of speech properties based upon the locating the first word in the dictionary;
means for examining words adjacent to the first word to determine which part of speech property the first word is; and
means for performing the following steps if a single part of speech property is not able to be determined from the examined adjacent words: selecting one of the adjacent words, examining part of speech properties of the words adjacent to the selected word, and determining a single part of speech property of the word based upon the examined part of speech properties of the words adjacent to the selected word.

31. The system of claim 23 wherein the parser module determines a single part of speech property for each of the words in order to classify each of the words as either a topic word, a prefix description word, or a postfix description word.

32. The system of claim 23 further comprising:
means for determining part of speech properties for the words;
means for parsing the text string into phrases based upon delimiters in the text string; and
means for identifying last noun of the first of the phrases as the topic word.

33. The system of claim 32 further comprising:
means for identifying nouns and adjectives before the topic word in the first of the phrases as the prefix description.

34. The system of claim 33 further comprising:
means for identifying as the postfix description nouns and adjectives in the phrases subsequent to the first phrase.

35. The system of claim 34 wherein the delimiters are items selected from the group consisting of commas, conjunctions, and prepositions.

36. The system of claim 23 wherein the filter module generates a first permutation of the topic word, prefix description, and postfix description,
wherein a first search of the data store is performed based upon the first permutation,
wherein the filter module generates a second permutation of the topic word, prefix description, and postfix description,
wherein a second search of the data store is performed based upon the second permutation, and
wherein the results from the first and second searches are scored based upon occurrence of the identified topic word, prefix description, and postfix description in the results.

37. The system of claim 23 wherein the data store is a data miner domain.

38. The system of claim 23 wherein the data store includes a plurality of data miner domains, wherein the filter module searches the data miner domains based upon the identified topic word, prefix description, and postfix description.

39. The system of claim 23 wherein a score of a search result is increased that has substantially same order of words found in the prefix description and the topic word.
